(19) United States
(12) Patent Application Publication
(10) Pub. No.: US 2010/0097683 A1
(43) Pub. Date: Apr. 22, 2010

(54) Neutral filter, light quantity adjustment apparatus, image pickup apparatus, manfacturing method of neutral filter, and die-cutting forming apparatus neutral filter

(75) Inventor: Akira TAKEI, Minamialps-shi (JP)

Correspondence Address: KANESAKA BERNER AND PARTNERS LLP, 1700 DIAGONAL RD, SUITE 310, ALEXANDRIA, VA, 22314-2848, US

(73) Assignee: NISCA CORPORATION, Minamikoma-gun (JP)

(21) Appl. No.: 12/585,519

(22) Filed: Sep. 17, 2009

(30) Foreign Application Priority Data
Oct. 21, 2008 (JP) 2008-271180

(51) Int. Cl. G02B 26/02; G02B 5/22; B32B 38/04; B26D 7/01

(52) U.S. Cl. 359/227; 359/888; 156/64; 83/75.5

(57) ABSTRACT

The present invention is to provide an optical filter for enabling a neutral filter for suppressing the quantity of passage light in an optical path to be mass-produced in an accurate position of an optical path opening with correct density characteristics without fluctuations, and the neutral filter is comprised of a filter 14 for suppressing a quantity of transmitted light, a base plate (aperture wheel) 11 attached with the filter to cause the filter to face the optical path, and alignment reference faces respectively formed in the base plate 11 and the filter 14 to define mutual bonding positions, where the filter 14 is formed into a predetermined outside shape by press forming from a transparent or translucent sheet with an light-reducing film formed on its surface, and is coated with the light-reducing film in which are formed two or more density regions having at least one density boundary line, while the outside shape of the filter 14 and the alignment reference faces are concurrently formed in beforehand set distance positions from the density boundary line by the press forming.

### BACKGROUND OF THE INVENTION

The present invention relates to an ND filter and other neutral filters used in optical devices such as a camera and the like, light quantity adjustment apparatus using the filter, and manufacturing method and forming apparatus of the filter, and more particularly, to improvements in a positioning mechanism for placing the filter with a predetermined density pattern formed therein in an accurate position in an optical path with a correct pattern shape.

Generally, this type of neutral filter is disposed in an optical path of an optical device such as a camera (image pickup apparatus) and the like, and has widely been used as a filter for attenuating the quantity of passage light. For example, in an image pickup apparatus, as an ND filter (Neutral Density filter), the filter is used to attenuate the quantity of shooting light to adjust an aperture.

FIG. 14 shows a structure and manufacturing method of a conventional ND filter. As shown in the figure, an aperture wheel (open/close member; as the case may be) is disposed in an optical path opening 11a to be openable and closable. In this case, it is required to reduce the aperture in a low aperture to slow the shutter speed to enable long-exposure shooting. Then, a filter (hereinafter, referred to as a “filter chip”) 14 is attached and bonded to the opening edge of the aperture wheel 11, and it is configured that a front end 14a for attenuating the light quantity faces the center of the optical path.

In a method of manufacturing such an aperture wheel, in attaching the filter chip 14 to the aperture wheel 11, the chip 14 and wheel 11 are bonded with an adhesive using a bonding tool 40. For example, the bonding tool 40 is formed of a mount 40 provided with a chip strike face (step height in the FIG. 40a against which an end face of the filter chip 14 is struck and regulated, and a wheel strike face (step height in the FIG. 40b against which an end face of the aperture wheel 11 is struck and regulated. In other words, the mount 40 forming the tool is provided with the strike face for positioning the filter chip 14 and the strike face for positioning the aperture wheel, the wheel position (attitude) and chip position (attitude) are regulated on the mount, and the wheel is thus manufactured so that the filter chip 14 is disposed in the optical path opening 11a in a predetermined attitude.

When a worker holds the aperture wheel 11 and filter chip 14 by hand and fingers to maintain until the adhesive is cured with the wheel 11 and chip 14 aligned on such a tool 40, such operation becomes a cause of misalignment between the wheel 11 and chip 14. Therefore, the applicant of the present invention proposed a method as shown in FIG. 13. In this method, as disclosed in Patent Document 1 [Japanese Laid-Open Patent Publication No. 2001-356386], positioning pins 40b, 40c are planted on a table-shaped mount 40. Then, fit holes adapted to the positioning pins 40b, 40c are disposed in an aperture wheel 11 as holes 11b, 11c, and similarly, a hole 14b and groove 14c are formed in a filter chip 14. Then, the poisoning pins 40b, 40c are fitted with the holes 11b, 11c of the aperture wheel, and further, fitted with the hole end face 14b and groove end face 14c of the filter chip thereon so as to stack. In addition, “14m” shown in the figure is a slit for adhesion formed in the filter chip 14, and “15” is an adhesive layer.

In this way, the positioning pins 40b, 40c which would be provided in one or more portions are fitted with the aperture wheel 11 to support, and further, fitted with the filter chip 14 to support, and it is thereby possible to prepare the wheel member without misalignment for a period during which both members are stacked and then, the adhesive is cured.

As described above, when end faces for positioning are formed in the filter chip and aperture wheel as a hole, groove, outer edge, etc. and positioning pins are fitted with the end faces to bond two plate-shaped members, the following problem occurs.

In the case of Patent Document 1 as described previously, the filter chip 14 is formed in a single density i.e. the entire chip is coated with a light-reducing film with a uniform density (uniform thickness). In such a single-density chip, when the shape of the chip facing the optical path opening and the area occupying the opening agree with predetermined design values, it is possible to mass-produce filters with the same function and light quantity adjustment apparatuses.

However, when a multi-density filter with different light transmittances is configured as a filter chip, in the chip, optical characteristics are varied with the density pattern changed even if the shape facing the optical path opening and the area are uniform. For example, in the case of multi-stage density filter configuration with the density pattern where the density changes in a stepwise manner, or in the case of gradation filter configuration with the density pattern where the density gradually decreases linearly, it is not possible to mass-produce filters with the same function unless the density pattern provided in the chip agrees with a beforehand set design value.

Then, when such a multi-density filter is produced by the conventional manufacturing method, there is only a method that a worker attaches and bonds the chip into an optimal position of the aperture wheel using an adhesive while visually checking the density pattern. In this method, as shown in FIG. 12, a light-reducing film is formed on a substrate F such as a plastic sheet or the like using a deposited film, etc. and a filter chip is formed from the sheet by die-cutting forming or the like. In this case, in the multi-density filter configuration, as shown in FIG. 12, on the sheet is formed a density pattern with a first density region ND1 and second density region ND2. In the pattern of FIG. 12, each of the regions ND1 and ND2 is formed in uniform density, and the light transmittance of the region ND1 is set to be higher than the light transmittance of the region ND2. Therefore, a density boundary line NL1 is drawn linearly on the boundary of regions. Then, filters are press-formed from the sheet material F using a die-cutting forming die of the shape as shown in the figure. At this point, when a gradient d occurs with respect to the density boundary line NL1, the area of the density region is different between the filter Y and filter Z. Thus, although the manufacturing is made in the same operation process, the filters Y and Z have different optical characteristics (particularly, optical absorption performance).

Accordingly, when a plurality of filters is formed from the conventional sheet material by die cutting, it is not possible to produce multi-density filters with uniform density characteristics unless the cutting die and density pattern are set and undergo die cutting so that all the wheels are uniform. However, conventionally, as shown in Patent Document 1 described previously, alignment reference faces (hole end face 14b and groove end face 14c shown in FIG. 13) are formed with reference to a single-density filter, and therefore, the above-mentioned problem has not been solved yet in the multi-density filter.

The inventor of the invention has reached an idea of forming the outer-edge shape and alignment reference faces (hole end face, groove end face, edge end face and the like) of a filter chip with reference to the boundary line in the density pattern so that a certain positional relationship is established in the three members (outer edge, end faces and boundary line), in forming a plurality of chips (wheel pieces) from a sheet material by die cutting in the process of producing the filter chips.

It is an object of the invention to provide an optical filter and manufacturing method thereof for enabling a neutral filter for suppressing the quantity of passage light in an optical path to be mass-produced in an accurate position of an optical path opening with correct density characteristics without fluctuations.

Further, it is another object of the invention to provide a die-cutting forming apparatus of a neutral filter enabling the outer shape and footprint of the neutral filter facing the optical path opening, and concurrently, the density pattern to agree easily with beforehand set design values.

### BRIEF SUMMARY OF THE INVENTION

To attain the above-mentioned objects, the present invention adopts the following configurations. The configuration is formed of a filter (14) for suppressing a quantity of transmitted light, a base plate (aperture wheel) (11) attached with the filter to cause the filter to face an optical path, and alignment reference faces respectively formed in the base plate (11) and the filter (14) to define mutual bonding positions, where the filter (14) is formed into a predetermined outside shape by press forming from a transparent or translucent sheet with an light-reducing film formed on its surface, and is coated with the light-reducing film in which are formed two or more density regions having at least one density boundary line, while the outside shape of the filter (14) and alignment reference faces are formed in beforehand set distance positions from the density boundary line by the press forming.

The light-reducing film forms a multi-stage density filter having a plurality of density regions such that the density changes in a stepwise manner from the center of the optical path toward the outside, or a gradation filter such that the density changes gradually.

The alignment reference face in the multi-stage density filter is provided in a position establishing a predetermined positional relationship with one of density boundary lines where the density changes in a plurality of stages, and the alignment reference face in the gradation filter is provided in a position establishing a predetermined positional relationship with the density boundary line formed on a boundary between a non-coated region formed in an opening edge of the sheet and a coated region.

The alignment reference face of the filter is formed of a cut end face of a circular hole, groove hole, notch end face and the like, while being concurrently formed by the press forming for forming the outside shape of the filter.

The alignment reference faces respectively formed in the base plate (11) and filter (14) are fitted with the same positioning pin, and thereby define the mutual bonding positions of the base plate and filter.

Alight quantity adjustment apparatus according to the invention is comprised of a substrate provided with an optical path opening, an aperture member for adjusting an aperture amount of the optical path opening, an opening edge provided in the aperture member to face the optical path opening, a neutral filter disposed in the opening edge, and driving means for shifting the aperture member to vary the aperture amount, and the aperture member is comprised of a base plate holding the filter, where the neutral filter has the above-mentioned configuration.

The aperture member is comprised of a pair of open/close members that relatively travel in opposite directions with respect to the optical path opening of the substrate, and the filter is attached and bonded to one of the pair of open/close members.

An image pickup apparatus according to the invention is comprised of an imaging optical path for guiding light from a subject in a predetermined direction, lens means for forming an image on an imaging surface using the light from the imaging optical path, imaging means disposed on the imaging surface to perform mapping of the light from the subject, and a light quantity adjustment apparatus for adjusting a quantity of the imaging light, where the light quantity adjustment apparatus has the above-mentioned configuration.

A method of manufacturing a neutral filter for forming a filter having light-reducing characteristics into a predetermined shape by die cutting to attach to a base plate is comprised of a wheel sheet forming step of forming a light-reducing film with a predetermined light transmittance in a transparent or translucent sheet material, a sheet setting step of positioning and setting the sheet material formed in the wheel sheet forming step in a die-cutting forming die, a density boundary line identifying step of optically reading a density pattern of the light-reducing film formed in the sheet material set in the predetermined position and identifying a boundary line of changes in density from the read pattern, die-cutting position correcting step of making a relative position adjustment to the sheet material and a die-cutting position of the die-cutting forming die with reference to the density boundary line identified in the boundary line identifying step, a wheel forming step of forming the sheet material into a predetermined shape by die cutting using the forming die corrected in position in the die-cutting position correcting step, and a bonding step of bonding the filter prepared in the wheel forming step to the base plate, where in the wheel forming step, an alignment reference face is formed concurrently with forming the sheet material into a predetermined shape by die cutting using the forming die, and formed in a predetermined positional relationship with the density boundary line.

A die-cutting forming apparatus of a neutral filter is to form a filter having light-reducing characteristics into a predetermined shape by die cutting to attach to a base plate, and has amount to position and set a material sheet having a light-reducing film formed in a predetermined density pattern, a die-cutting forming die to form the sheet material on the mount into a predetermined shape by die cutting, density pattern reading means for optically reading a density pattern of the sheet material on the mount, display means for displaying at least a boundary line of changes in density of the pattern read in the density pattern reading means, shift means for making a position correction to the sheet material on the mount and/or a die-cutting position of the die-cutting forming die based on the density boundary line displayed in the display means, and driving means for pressing the die-cutting forming die to form the sheet material on the mount into a predetermined shape by die cutting.

The shift means is comprised of table means for mounting the sheet material thereon to enable the sheet material to move to positions in X-Y horizontal direction, and handle operation means for shifting a position in the horizontal direction of the table means.

The present invention is to form a transparent or translucent sheet material with a light-reducing film formed on its surface into a predetermined wheel shape, while aligning the outside shape of the wheel, and concurrently, alignment reference faces defining a bonding position to the base plate with reference to the density boundary line formed in the density region to form, and has the effects as described below.

In forming a sheet material having predetermined light-reducing characteristics by die cutting, since the outside shape of the wheel and alignment reference faces to attach to a base plate such as an aperture wheel are concurrently formed, by regulating positions of the end faces (hole end face, groove end face, edge end face, etc.) using positioning pins or the like to attach, it is possible to place the filter in the optical path opening with the outside shape and footprint conforming to beforehand set design values. Concurrently therewith, the alignment reference faces and the outside shape are formed in alignment with reference to the density boundary line, and it is thereby possible to adjust density characteristics of the filter facing the optical path opening to the optimal value.

Particularly, the present invention is to form a light-reducing film with two or more density regions having at least one density boundary line, is to set a die-cutting position with reference to a selected single density boundary line in the case of a multi-stage density wheel formed in stages of two or more, while setting a die-cutting position with reference to the boundary between the non-coated region and the density region continued from the non-coated region formed in the opening edge of the wheel in the case of a gradation wheel such that the density characteristics gradually decrease linearly, and thereby has the outstanding effect that the invention is applicable to wheels with wide-ranging density characteristics, and so on.

### BRIEF DESCRIPTION OF THE SEVERAL VIEWS OF THE DRAWINGS

FIG. 1 contains structure explanatory views of a neutral filter A according to the invention, where FIG. 1(a) is a state explanatory view of stacking a filter on abase plate (aperture wheel), and FIG. 1(b) is a state explanatory view after stacking;

FIG. 2 is an exploded view showing a structure of alight quantity adjustment apparatus B according to the invention;

FIG. 3 is an explanatory view of press forming for forming the neutral filter A of FIG. 1 from a sheet material by die cutting;

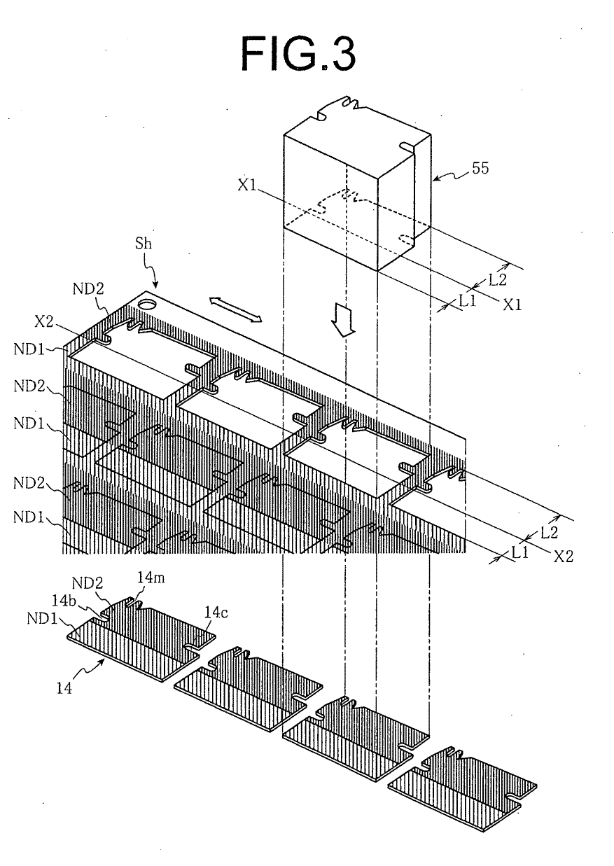

FIG. 4 shows a manufacturing process of the neutral filter A of FIG. 1 and is an explanatory view of a state where the sheet material is set on a mount;

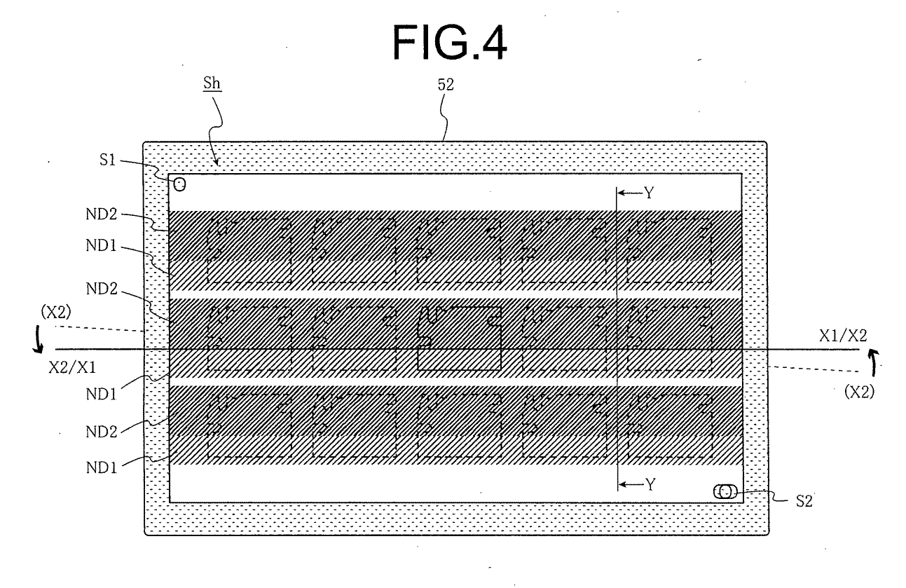

FIG. 5 is an explanatory view of the relationship between a density characteristic curve and density pattern when the neutral filter A of FIG. 1 is formed of two-stage density regions;

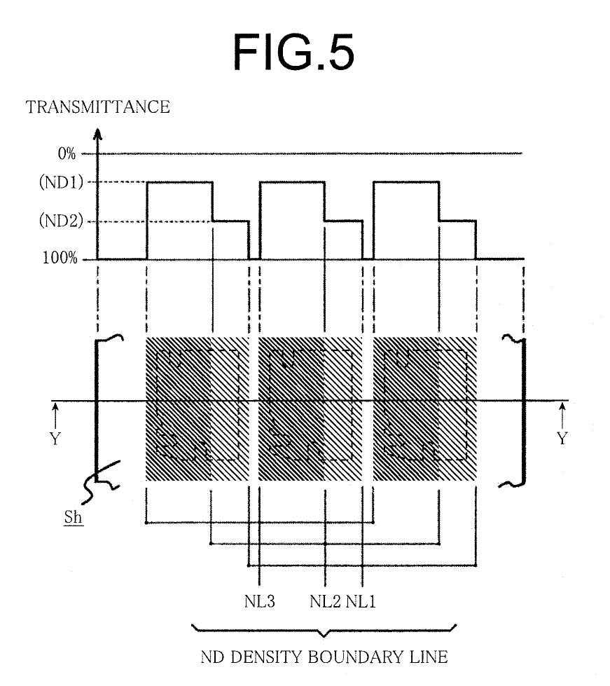

FIG. 6 is an explanatory view of a die-cutting forming apparatus used in a manufacturing process of the neutral filter A of FIG. 1;

FIG. 7 contains explanatory views of corrections of a die-cutting position of the sheet material in the die-cutting forming apparatus of FIG. 6, where FIG. 7(a) is a state explanatory view when the sheet material Sh is inclined at an angle of α, and FIG. 7(b) is a state explanatory view when the density pattern of the sheet material Sh is misaligned in the horizontal direction;

FIG. 8 is a process explanatory diagram of a method of manufacturing a neutral filter of the invention;

FIG. 9 shows density patterns of the neutral filter of the invention, where FIG. 9(a) shows a pattern of a multi-stage density filter SF, and FIG. 9(b) shows a pattern of a gradation filter GF;

FIG. 10 shows density characteristics of the neutral filter of the invention, where FIG. 10(a) shows changes in density of the multi-stage density filter SF, and FIG. 10(b) shows changes in density of the gradation filter GF;

FIG. 11 is a structure explanatory view of an image pickup apparatus of the invention;

FIG. 12 is an explanatory view of defects when there is a gradient between the sheet material Sh and die-cutting position in forming filters by die cutting;

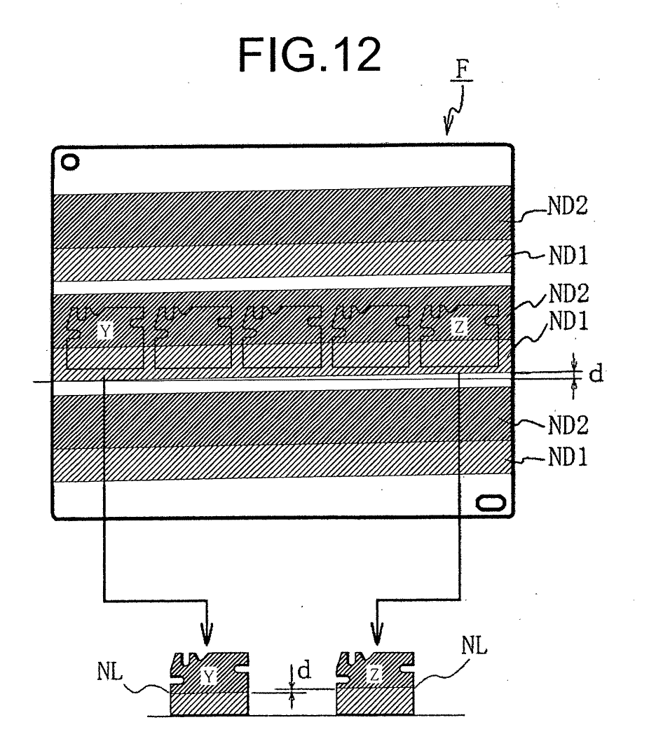

FIG. 13 is an explanatory view of a bonding process in a conventional method of forming a filter by die cutting and the like; and

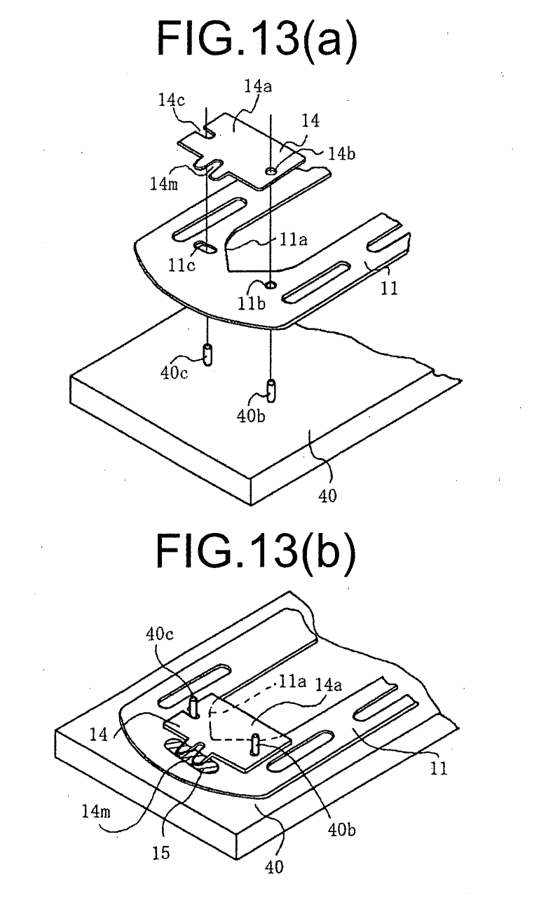

FIG. 14 is an explanatory view of alignment of the filter and base plate in the conventional method of forming a filter by die cutting and the like.

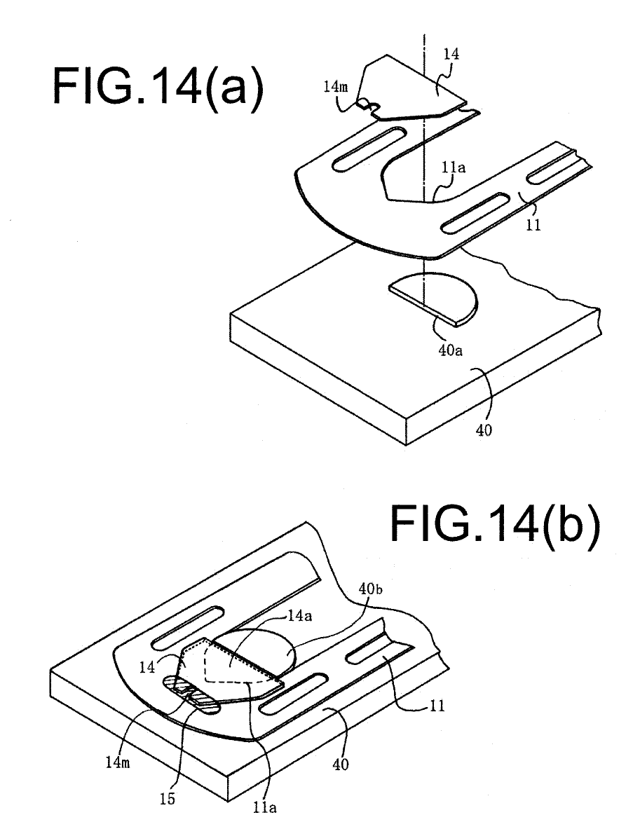

### DETAILED DESCRIPTION OF THE INVENTION

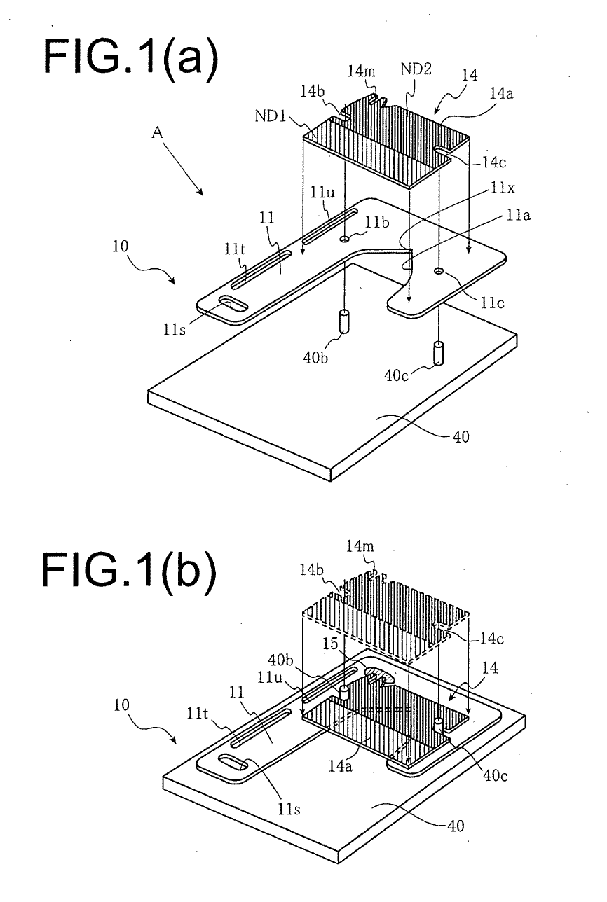

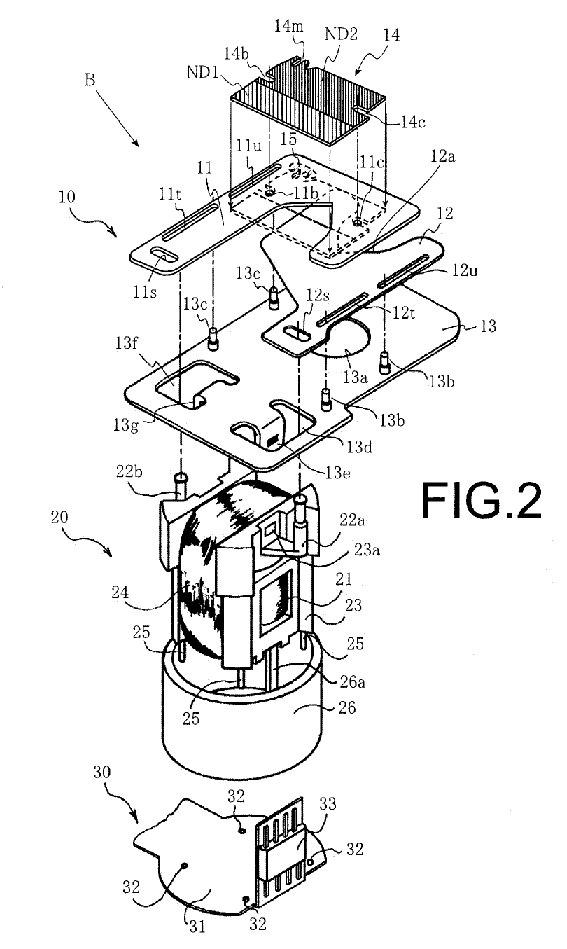

The present invention will specifically be described below based on preferred embodiments shown in the drawings. FIG. 1 contains explanatory views showing a configuration of a neutral filter A according to the invention, and an alignment method for defining a bonding position to a base plate (aperture wheel). FIG. 2 is an exploded view of a light quantity adjustment apparatus B according to the invention. The invention will be described below in the order of the “configuration of the neutral filter”, “configuration of the light quantity adjustment apparatus”, “configuration of an image pickup apparatus”, “manufacturing method of the neutral filter”, and “die-cutting forming die (apparatus) of the neutral filter”.

### [Configuration of the Neutral Filter]

As shown in FIG. 1 and part of FIG. 2, the neutral filter A according to the invention is formed of a base plate (hereinafter, referred to as an “aperture wheel”) 11, and a filter (hereinafter, referred to as a “filter chip”) 14. The base plate 11 as shown in the figure is comprised of an aperture wheel of the light quantity adjustment apparatus B described later. This base plate is made of a metal thin plate, plastic thin plate or the like, and disposed in an optical path of an optical device such as an imaging optical path. In other words, in the light quantity adjustment apparatus B in the image pickup apparatus as shown in FIG. 2, the base plate is comprised of the aperture wheel 11 that is disposed in an optical path opening 13a formed in a substrate 13 of the light quantity adjustment apparatus B to adjust the aperture amount. Moreover, the base plate can be comprised of a framework supporting the filter in an optical path.

The above-mentioned base plate 11 is made of a plastic thin plate, formed of one of a pair of aperture wheels 11, 12 described later, and is provided with an opening edge 11a facing the optical path opening 13a, and a narrowing edge 11x for a small aperture formed in the opening edge 11a. “11u” and “lit” shown in the figure are guide grooves and both formed in the base plate 11. In the configuration of the light quantity adjustment apparatus B described later, the guide grooves are engaged in guide pins 13c planted in the substrate 13, and the base plate (hereinafter, referred to as an “aperture wheel”) 11 is slid in the right and left direction viewed in FIG. 2 to pass through the optical opening 13a of the substrate 13. By this means, the opening edge 11a formed in the base plate 11 is guided by the guide pins 13c to adjust the aperture amount of the optical path opening 13a. “11s” shown in FIG. 1 is a driving-pin engagement hole, and a driving pin 22b coupled to a driving motor 20 (see FIG. 2) is engaged in the engagement hole 11s. The driving motor 20 and driving pin 22b constitute driving means for opening and closing the aperture wheel 11.

The filter chip 14 is attached and bonded to the opening edge 11a of the base plate 11, and is formed of a chip protruding toward the center of the optical path opening 13a. The filter chip 14 is comprised of a light-reducing film ND (generic name for ND1 and ND2 shown in the figure) coated on the sheet material Sh as described later. In other words, in the aperture wheel 11 for opening and closing the optical path opening 13 to adjust the opening diameter, the filter chip 14 is attached to the narrowing edge 11x of the opening edge 11a forming a small aperture. In the filter chip 14, the light-reducing film ND of the density pattern described later is formed on a transparent or translucent material.

Then, in the filter chip 14 are formed alignment reference faces 14b, 14c defining a bonding position in bonding to the aperture wheel 11. The alignment reference face is formed in one, two or three, or more portions, and formed to define the attitude in the horizontal direction of the filter chip 14. In other words, the alignment reference face is formed of a groove end face long in the horizontal direction in the case of a chip with a single portion. Alternately, in the case of a chip with two or three portions, a plurality of alignment reference faces are formed of a hole end face or edge end face and provided in positions a distance apart from one another in the horizontal direction. Positioning pins 40b, 40c described later are fitted with the alignment reference faces 14b, 14c, and the aperture wheel 11 having the same alignment reference faces (holes) 11b, 11c as the end faces 14b, 14c is positioned. In other words, in the filter chip 14 and aperture wheel 11 are formed alignment reference faces (holes) 11b, 11c and 14b, 14c in the same portions, respectively, and by engaging the common positioning pins 40b, 40c in both end faces, it is possible to position the filter chip 14 and aperture wheel 11 in predetermined positions. In addition, a slit 14m formed in the filter chip 14 is a reservoir groove of an adhesive, and “15” shown in the figure is an adhesive layer, and is used to bond the filter chip 14 to the aperture wheel 11.

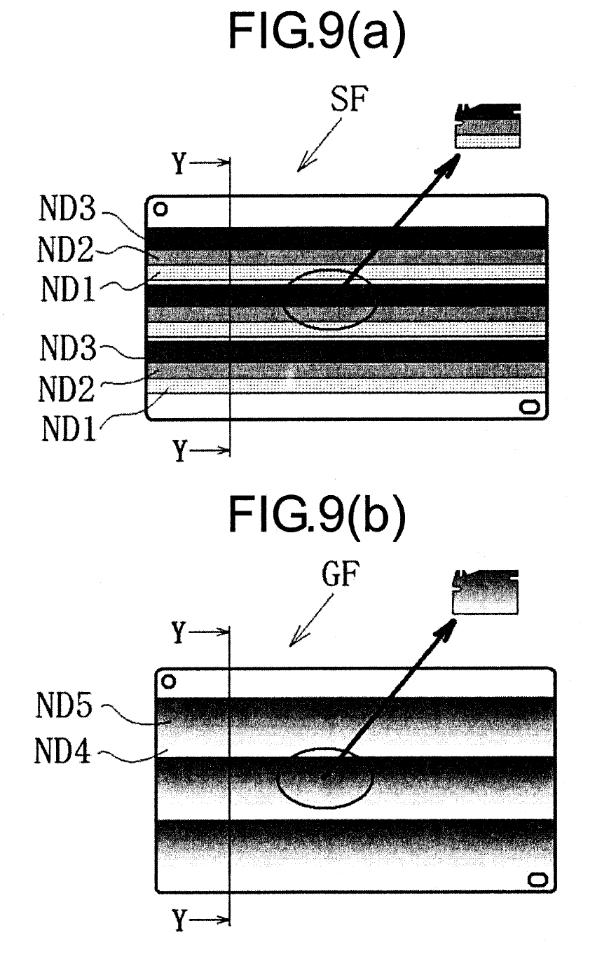

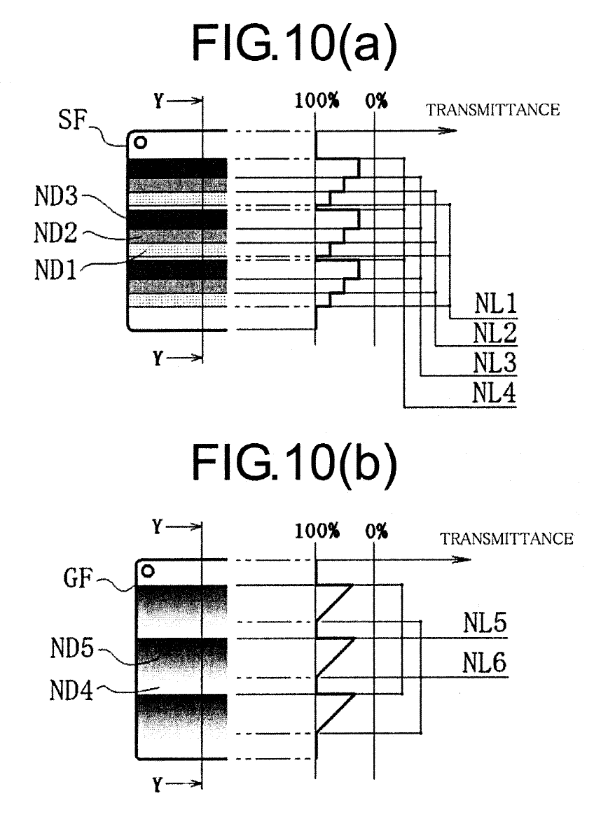

The light-reducing film ND formed in the filter chip 14 will be described. The filter chip 14 according to the invention adopts a “multi-stage density filter” structure of a multi-density pattern having two ore more density regions ND1, ND2 with different light transmittances, and a “gradation filter” structure such that the density linearly changes (gradually decreases). FIG. 9(a) shows the density pattern of the multi-stage density filter SF, and FIG. 9(b) shows the density pattern of the gradation filter GF. Further, FIG. 10(a) schematically shows the light transmittance of the multi-stage density filter SF, and FIG. 10(b) schematically shows the light transmittance of the gradation filter GF.

As the multi-stage density filter SF, as shown in FIG. 9(a), a light-reducing film is formed on a plastic sheet of an appropriate shape using a deposited film or the like. The light-reducing film is formed in film thicknesses with different transmittances in a first density region ND1, second density region ND2 and third density region ND3. Accordingly, as shown in FIG. 10(a), the transmittances (≈densities) are different in the first density region ND1, second density region ND2 and third density region ND3, and formed in multi-stage such as two stages, three stages, etc. so that the density increases in a stepwise manner such that transmittance of ND1<transmittance of ND2<transmittance of ND3. On boundaries between the density regions are formed density boundary lines NL1, NL2, NL3 and NL4. In addition, NL1 shown in the figure is a density boundary line formed on the boundary between the non-coated region (to be precise, material density) and the first density region ND1. The density boundary lines NL1, NL2, NL3 and NL4 may be visually identified, or difficult to visually identify.

As the gradation filter GF, as shown in FIG. 9(b), a light-reducing film is formed on a plastic sheet using a deposited film or the like. In this case, the light-reducing film ND is formed so that the density linearly decreases gradually. In other words, as shown in FIG. 10(b), the film is formed so that the density gradually changes in the non-coated region (to be precise, material density) ND4 and density gradually-increasing region ND5, and a density boundary line NL6 is formed on a boundary between the non-coated region ND4 and density gradually-increasing region ND5. The density boundary line NL6 may be visually identified, or difficult to visually identify, as in the foregoing.

In the above-mentioned neutral filter A, the light-reducing film is formed in the density pattern of the multi-stage density filter SF, gradation filter GF or the like. Therefore, even when the positional relationship (dimensions) between the outside shape of the filter chip 14 and alignment reference faces 14b, 14c agrees with design dimensions, the problem arises that the density pattern varies for each wheel. Then, it is a feature of the invention that the positional relationship between the density pattern and alignment reference faces 14b, 14c is made to agree with the beforehand set design value by a method as described later (see the “manufacturing method of the neutral filter”).

### [Configuration of the Light Quantity Adjustment Apparatus]

Described next is the light quantity adjustment apparatus B using the above-mentioned neutral filter A. FIG. 2 shows an exploded view (perspective view) of the apparatus B. A light quantity adjustment unit 10 is comprised of the substrate (base board) 13, a pair of aperture wheels (aperture open/close members) 11, 12 disposed in the substrate 13, and driving motor 20 for driving the aperture wheels 11, 12 to open and close. The substrate (base board) 13 is provided with the optical path opening 13a, and a pair of aperture wheels 11, 12 are supported on the base board 13 to rotate and travel in the opposite directions so as to adjust the aperture amount of the optical path opening 13a. In the aperture wheels 11, 12 are formed opening edges 11a, 12a. The filter chip 14 is attached to the opening edge 11a of one aperture wheel 11. The configuration is as described previously based on FIG. 1. “13b” and “13c” shown in the figure denote guide pins to support the aperture wheels 11, 12 slidably, and “13e” and “13g” in the figure denote bent fixing portions that support the driving motor 20 to be secured.

The driving motor 20 for opening and closing the light quantity adjustment apparatus 10 as appropriate has locking tabs 23a locked by the bent fixing portions 13e, 13g of the base board 13, engaging arms 22a, 22b extending from both sides of the driving motor 20 to engage in driving-pin engagement holes 11s, 12s of the aperture wheels 11, 12 via notch holes 13d, 13f of the base board 13, a conductive coil 24 with lap winding driving coil and damping coil wound around an outer region 23, lead terminals 25 to electrically lead coil ends of the conductive coil 24, magnet rotor 21 supported inside the housing rotatably to swing the engaging arms 22a, 22b, and yoke 26 made of a C-shaped magnetic material with apart of side 26a cut to magnetically determine a position of the magnet rotor 21 in non-operation.

A connection terminal portion 30 for supplying power to the driving motor 20 from an outside apparatus to drive as appropriate has an electrode pattern 32, in a support portion 31 soldered to the driving motor 20, for connecting each lead terminal 25 of the conductive coil 24 to the outside power supply, and magnetism detecting element 33 faced toward the magnetic pole of the magnet rotor 21 to detect a change in magnetism, further detect an aperture opening amount at this point, and output a control signal for controlling to a correct aperture.

The aperture apparatus comprised of the above-mentioned structure is installed into a lens unit of an optical device such as a camera or the like, narrows a quantity of light passed through the optical path opening 13a by the aperture wheels 11, 12 and thereby makes a light quantity adjustment. At this point, as the intensity of outside light increases, the aperture is narrowed, and the filter chip 14 enters inside the optical path more than an aperture position of a predetermined amount to transmit and attenuate the quantity of light. Concurrently, the aperture by the aperture wheels 11, 12 is increased to prevent a diffraction phenomenon from occurring.

Described next is a bonding structure of the filter chip 14 provided in the aperture wheel 11 of the aperture apparatus based on FIG. 1. FIG. 1 shows a first embodiment of the bonding structure of the filter chip 14, where FIG. 1(a) shows the state before bonding, and FIG. 1(b) shows the state after bonding. As shown in the figure, a tool 40 is provided with the positioning pins 40b, 40c. In the aperture wheel 11 are formed the reference faces (holes) 11b, 11c fitted with the positioning pins 40b, 40c, and similarly, in the filter chip 14 are formed the alignment reference faces 14b, 14c fitted with the positioning pins 40b, 40c. The filter chip 14 further has the groove-shaped bonding portion (reservoir groove) 14m formed to prevent the adhesive 15 from flowing in the filter use face 14a. As shown in the figure, the aperture wheel 11 is set on the tool 40, the filter chip 14 is further stacked and held, and using the adhesive 15, the bonding portion (reservoir groove) 14m of the filter chip 14 is bonded to the aperture wheel 11. In this condition, the chip 14 and wheel 11 are allowed to stand for a while until the adhesive 15 is dried to some extent, and bonded completely without misalignment.

In addition, the engagement members such as hole portions, notch portions or the like provided to position the filter chip with respect to the light quantity adjustment means to bond are usually shielded by the other light quantity adjustment means or the base board supporting the light quantity adjustment means slidably, and do not cause problems that the light leaks to the opening portion of the camera, etc. and others. Further, in the aforementioned embodiment, the light quantity adjustment means is obtained by bonding the filter chip to the aperture wheel for narrowing the opening diameter of the opening portion, but may be obtained by bonding the filter chip simply to a member of a shape resembling a wheel going in and out of the opening portion.

### [Image Pickup Apparatus]

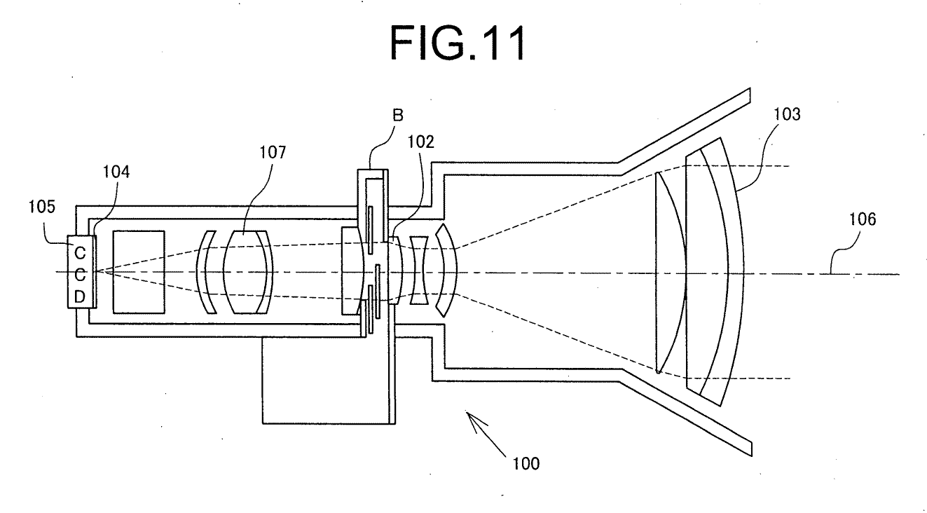

Described next is an image pickup apparatus installed with the light quantity adjustment apparatus B as described above. FIG. 11 shows a principal part (lens-barrel portion) of the image pickup apparatus. An optical path (imaging optical path) 106 is formed in the lens-barrel (image pickup optical system) 100. In the optical path 106 are arranged a front lens 103, main lens 102, rear lens 107 in this order. Then, an imaging device (CCD device) 105 is disposed on an imaging surface 104 of the main lens 102. Then, the light quantity adjustment apparatus B is disposed between the main lens 102 and rear lens 107. The configuration of the light quantity adjustment apparatus B is as described previously based on FIG. 2.

The light (imaging light) from a subject is guided to the main lens 102 from the front lens 103, and the image is formed on the imaging surface 104 where the imaging device 105 is disposed. During this process, the quantity of shooting light is adjusted by the light quantity adjustment apparatus B, and the light reaches the imaging surface 104. The light undergoes photoelectric conversion by the imaging device 105 on the imaging surface 104, and the image data is output as an electric signal.

Then, when the quantity of light entering the optical path 106 is large, the light quantity adjustment apparatus B adjusts the quantity of shooting light using the aperture wheel 11 and filter chip 14. In this light quantity adjustment, the quantity of light is adjusted by increasing or decreasing the optical path diameter by the aperture wheel 11, and the filter chip 14 adjusts the transmittance of the quantity of passage light to increase or decrease.

### [Manufacturing Method of the Neutral Filter]

Described next is a method of forming the light quantity adjustment filter. It is a feature of the invention forming a light-reducing film on the sheet material Sh of an appropriate size, cutting the sheet material Sh to form the filter chip 14 using a press die 55, and thereby forming a plurality of filter chips 14 concurrently. Each step will be described below.

### [Wheel Sheet Forming Step]

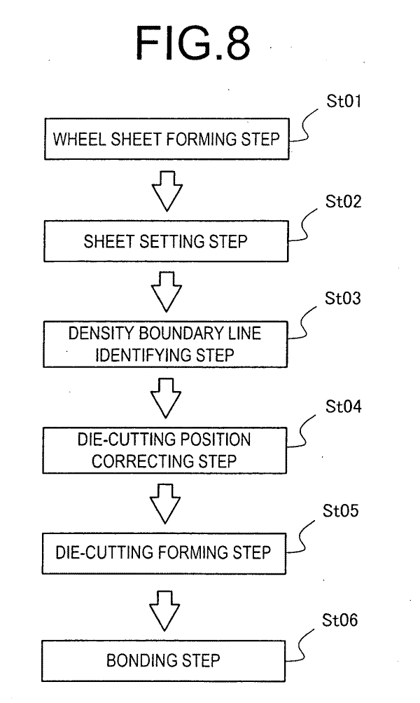

Prepared first is the sheet material of the filter chip. For the neutral filter A shown in the figure, the sheet material Sh is formed of transparent or translucent synthetic resin. As the sheet material Sh, for example, norbornene resin excellent in temperature characteristics is shaped into a sheet form. A light-reducing film is formed on the sheet surface. This light-reducing film is obtained by stacking a light absorption material layer and dielectric layer alternately, forming a hard coating (for example, magnesium fluoride (MgF₂) film) on the top layer, and finally performing coating processing on the entire film layer with water repellent coating (FIG. 8 (St01)). In thus formed sheet material Sh, a band-shaped density pattern is formed as shown in FIG. 9. FIG. 9(a) shows the multi-stage density filter, and FIG. 9(b) shows the gradation filter.

### [Sheet Setting Step]

The sheet material Sh manufactured in the above-mentioned process is mounted on a mount 51 of a die-cutting forming apparatus as described later, and set by a clamp mechanism to be secured (FIG. 8 (St02)).

### [Density Boundary Line Identifying Step]

Image reading means 60 reads the density pattern of the sheet material Sh set on the mount 51 in the aforementioned step as an image. The image reading means 60 shown in the figure is comprised of a CCD camera. Accordingly, the density pattern of the sheet material Sh on the mount 51 is subjected to signal processing as an electric signal, and displayed by display means (not shown). In this case, when the multi-stage density filter SF (FIG. 9(a)) or gradation filter GF (FIG. 9(b)) can be visually identified, the signal is transferred to the display means without being modified. Meanwhile, when the density pattern cannot be visually identified, the density boundary line NL is extracted by image processing and corrected to be emphasized. In the density boundary line extraction, in the case of the multi-stage density filter SF, extracted is the edge (contour) of changes in density appearing in a stepwise manner as shown in FIG. 10(a). Meanwhile, in the case of the gradation filter GF, extracted is a boundary between the non-coated region (blank portion where the light-reducing film is not formed) and the portion where the density coating is formed as shown in FIG. 10(b). Then, the boundary line thus subjected to the image processing is emphasized and expressed by contrast, color, etc. to enable visual identification thereof (FIG. 8 (St03)).

The density pattern of the sheet material Sh set on the mount 51 in such steps is read by the image reading means 60, and the density boundary ling NL is extracted in the image processing, and emphasized and displayed in the display means not shown.

### [Die-Cutting Position Correcting Step]

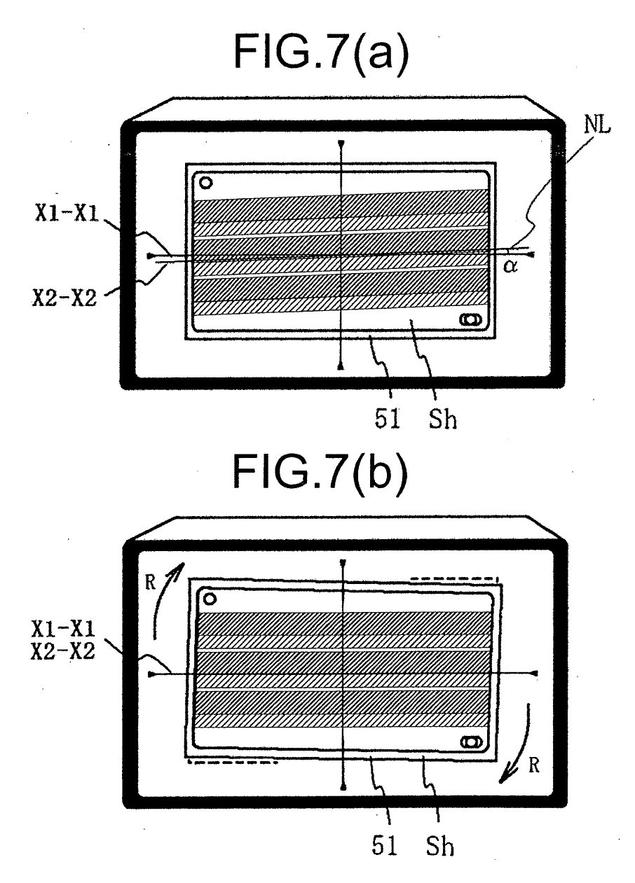

The density pattern of the sheet material Sh set on the mount 51 as described above is displayed in the display means, as well as the density boundary line NL. Therefore, an operator corrects the position of table means 52 mounted with the sheet material Sh while viewing the di splay means. This position correction is to correct a die-cutting position of the press die 55 with reference to the density boundary line NL formed in the density pattern. For example, by shifting the position of the density boundary line NL in the direction of FIG. 7(a), it is possible to match the density region of the filter chip 14 with the beforehand set design value. Further, also when a gradient a is formed with respect to the density boundary line NL, it is possible to correct the gradient by rotating the mount 51 (FIG. 8 (ST04)).

### [Die-Cutting Forming Step]

The positional relationship between the sheet material Sh and press die 55 is corrected in the position correcting step, and the outside shape, alignment reference faces and density pattern of the filter chip 14 are set for a certain positional relationship (design value). Then, the operator operates an operating button not shown to cause the press die 55 to execute press motion. Upon the motion, wheels corresponding to the number of press dies 55 are mass-produced from the sheet material Sh (FIG. 8 (St05)).

### [Bonding Step]

The operator next positions and sets the aperture wheel 11 in the assembly tool (tool) 40. At this point, the alignment reference faces (holes) 11b, 11c formed in the wheel 11 are fitted with the positioning ping 40b, 40c. Next, the operator stacks the filter chip 14 on the aperture wheel 11. At this point, the alignment reference faces (holes) 14b, 14c formed in the filter chip 14 are fitted with the positioning ping 40b, 40c. Subsequently, the operator drops an adhesive into the bonding portion (reservoir groove) 14m formed in the filter chip 14 to fix (FIG. 8 (St06)).

### [Die-Cutting Forming Apparatus of the Neutral Filter]

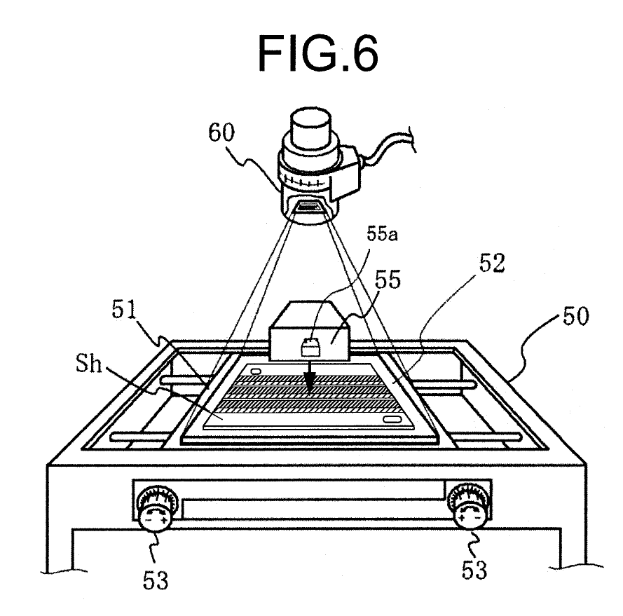

The die-cutting forming die (apparatus) used in the above-mentioned manufacturing method will be described below according to FIG. 6. As shown in FIG. 6, the apparatus is comprised of an apparatus frame 50, mount 51, table means 52, image reading means 60 and press die 55.

The apparatus frame 50 is configured in appropriate workbench form, and provided with the mount 51. The mount 51 supports the table means 52 to be movable in the X-Y direction. This table means 52 supports the sheet material Sh, and is configured to be movable in the horizontal direction (X-Y direction) and in the rotation direction (R direction). Further, the table means 52 is equipped with a clamp mechanism, not shown, for securing the sheet material Sh. Accordingly, the sheet material Sh fixed and set onto the table means 52 is capable of moving to positions in the horizontal direction (X-Y direction), and concurrently, is configured to be able to rotate in the rotation direction (R direction). Then, it is configured that the operation of handle operation means 53 enables the table means 52 to move to positions in the X-Y direction and in the R-direction.

The image reading means 60 is comprised of image pickup (camera) means for shooting the density pattern of the sheet material Sh fixed and set onto the table means 52. Not shown in the figure, but provided further is the display means to view the image read by the image reading means 60. Accordingly, in the sheet material Sh mounted and fixed onto the table means 52, the shape and density pattern are read by the image reading means 60 as the image data, and are displayed in the display means (display, etc. not shown). Accordingly, the operator is capable of moving the sheet material Sh on the table means 52 to positions in the X-Y direction or rotating in the R direction while viewing the display means. Then, this operation is executed manually using the handle operation means 53.

The table means 52 is provided with the press die 55. This press die 55 is provided with a movable die and fixed die that are respectively provided upward and downward across the sheet material Sh. “55a” shown in the figure denotes a movable male die, and the movable male die 55a is supported to be able to move up and down along a guide stem not shown, and is coupled to hydraulic transmission means (not shown). Accordingly, by controlling the hydraulic transmission means, the movable male die 55a moves down, and cuts the sheet material Sh together with the fixed female die to perform forming. The male die and female die (hereinafter, referred to as the “press die 55”) form the sheet material Sh into the designed outside shape, and concurrently, form the alignment reference faces 14b, 14c described as previously.

In thus configured die-cutting forming apparatus, the density pattern of the sheet material Sh set on the table means 52 is read by the image reading means 60, and displayed in the display means (not shown in the figure). Then, since the table means 52 is configured to enable its position to be adjusted in the X-Y direction and in the rotation direction R, the operator adjusts the position while viewing the display means, and after ma king the position correction, operates the press die 55. By this means, it is possible to form the filter chip 14 with the outside shape having the beforehand set design dimensions, and to concurrently form the alignment reference faces 14b, 14c. This alignment enables the positional relationship of the density pattern, the outside shape and alignment reference faces 14b, 14c of the filter chip 14 to agree with the design values.

In addition, in the present invention, the correction of the die-cutting position is described in the case of rotating the table means 52 chucking the sheet material Sh in the X-Y direction and in the R direction, but naturally, may be configured that the sheet material Sh is fixed, and that the press die 55 is parallel-shifted in the X-Y direction and rotary-shifted in the R direction. Further, a chucking mechanism for chucking the sheet material Sh to the mount 51 may be configured detachably, and an operator may release the chucking mechanism to make a position correction to the sheet material Sh.

What is claimed is:

1. A neutral filter disposed in an optical path of imaging light to suppress a quantity of passage light, comprising:
a filter for suppressing a quantity of transmitted light;
a base plate attached with the filter to cause the filter to face the optical path; and
alignment reference faces respectively formed in the base plate and the filter to define mutual bonding positions,
wherein the filter is formed into a predetermined outside shape by press forming from a transparent or translucent sheet with an light-reducing film formed on a surface thereof, and is coated with the light-reducing film in which are formed two or more density regions having at least one density boundary line,
an alignment reference face formed in the filter is formed in a beforehand set distance position from the density boundary line by the press forming for the outside shape, and
the outside shape of the filter and the alignment reference face are formed in beforehand set distance positions from the density boundary line by the press forming.

2. The neutral filter according to claim 1, wherein the light-reducing film forms a multi-stage density filter having a plurality of density regions such that the density changes in a stepwise manner from the center of the optical path toward the outside, or a gradation filter such that the density changes gradually.

3. The neutral filter according to claim 1, wherein the alignment reference face in the multi-stage density filter is provided in a position establishing a predetermined positional relationship with one of density boundary lines where the density changes in a plurality of stages, and
the alignment reference face in the gradation filter is provided in a position establishing a predetermined positional relationship with the density boundary line formed on a boundary between a non-coated region formed in an opening edge of the sheet and a coated region.

4. The neutral filter according to claim 1, wherein the alignment reference face of the filter is formed of a cut end face of a circular hole, groove hole, or notch end face, while being concurrently formed by the press forming for forming the outside shape of the filter.

5. The neutral filter according to claim 1, wherein the alignment reference faces respectively formed in the base plate and the filter are fitted with the same positioning pin, and thereby define the mutual bonding positions of the base plate and the filter.

6. A light quantity adjustment apparatus comprising:
a substrate provided with an optical path opening;
an aperture member for adjusting an aperture amount of the optical path opening;
an opening edge provided in the aperture member to face the optical path opening;
a neutral filter disposed in the opening edge; and
driving means for shifting the aperture member to vary the aperture amount,
wherein the aperture member is comprised of a base plate holding the filter, and the neutral filter has a configuration according to claim 1.

7. The light quantity adjustment apparatus according to claim 6, wherein the aperture member is comprised of a pair of open/close members that relatively travel in opposite directions with respect to the optical path opening of the substrate, and
the filter is attached and bonded to one of the pair of open/close members.

8. An image pickup apparatus comprising:
an imaging optical path for guiding light from a subject in a predetermined direction;
lens means for forming an image on an imaging surface using the light from the imaging optical path;
imaging means disposed on the imaging surface to perform mapping of the light from the subject; and
a light quantity adjustment apparatus disposed in the imaging optical path to adjust a quantity of the imaging light,
wherein the light quantity adjustment apparatus has a configuration according to claim 6.

9. A method of manufacturing a neutral filter for forming a filter having light-reducing characteristics into a predetermined shape by die cutting to attach to a base plate, comprising:
a wheel sheet forming step of forming a light-reducing film with a predetermined light transmittance in a transparent or translucent sheet material;
a sheet setting step of positioning and setting the sheet material formed in the wheel sheet forming step in a die-cutting forming die;
a density boundary line identifying step of optically reading a density pattern of the light-reducing film formed in the sheet material set in a predetermined position and identifying a boundary line of changes in density from the read pattern;
a die-cutting position correcting step of making a relative position adjustment to the sheet material and a die-cutting position of the die-cutting forming die with reference to the density boundary line identified in the boundary line identifying step;
a wheel forming step of forming the sheet material into a predetermined shape by die cutting using the forming die corrected in position in the die-cutting position correcting step; and
a bonding step of bonding the filter prepared in the wheel forming step to the base plate,
wherein in the wheel forming step, an alignment reference face is formed concurrently with forming the sheet material into a predetermined shape by die cutting using the forming die, and formed in a predetermined positional relationship with the density boundary line.

10. A die-cutting forming apparatus of a neutral filter for forming a filter having light-reducing characteristics into a predetermined shape by die cutting to attach to a base plate, comprising:
a mount to position and set a sheet material having a light-reducing film formed in a predetermined density pattern;
a die-cutting forming die to form the sheet material on the mount into a predetermined shape by die cutting;
density pattern reading means for optically reading the density pattern of the sheet material on the mount;
display means for displaying at least a boundary line of changes in density of the pattern read in the density pattern reading means;
shift means for making a position correction to the sheet material on the mount and/or a die-cutting position of the die-cutting forming die based on the density boundary line displayed in the display means; and
driving means for pressing the die-cutting forming die to form the sheet material on the mount into a predetermined shape by die cutting.

11. The die-cutting forming apparatus of a neutral filter according to claim 10, wherein the shift means is comprised of table means for mounting the sheet material thereon to enable the sheet material to move to positions in X-Y horizontal direction, and handle operation means for shifting a position in the horizontal direction of the table means.
